(19) United States
(12) Patent Application Publication
(10) Pub. No.: US 2013/0226500 A1
(43) Pub. Date: Aug. 29, 2013

(54) DETERMINATION OF VALIDITY OF BI-LEVEL DIGITAL SIGNAL VIA DIGITAL DATA ACQUISITION

(71) Applicant: Kevin D. Russo, Canton, MI (US)

(72) Inventor: Kevin D. Russo, Canton, MI (US)

(73) Assignee: YAZAKI NORTH AMERICA, INC., Canton, MI (US)

(21) Appl. No.: 13/405,652

(22) Filed: Feb. 27, 2012

(51) Int. Cl. G06F 19/00

(52) U.S. Cl. 702/120

(57) ABSTRACT

A system for testing the output of a digital gauge controller is disclosed. The system is configured to receive a multi-component digital signal and test if a plurality of thresholds are reached for individual components of the digital signal. If a first expected level is met, the system then determines if a second component of the multi-component signal meets a second expected level.

### FIELD

The present teachings relate to a test device for testing the output of a controller and, more particularly, to a test device which evaluates a multi-component digital output signal of a gauge controller.

### BACKGROUND

Because digital controllers are becoming more complex, and are operating at ever-increasing speeds, the equipment for testing such controllers is also becoming more complex and more expensive. Developments in test equipment which provide lower costs and better testing techniques are, therefore, most useful.

Controllers are customarily tested after component assembly is completed in order to find and remove any defects. Whether they are related to manufacturing (such as solder shorts, copper shorts or wrong, misplaced or missing components), defective components, or errors in software installation, expected outputs in response to predetermined inputs are typically evaluated.

Instrument cluster controllers are customarily evaluated by probing the board at strategic testing locations and by optical observation of the gauge cluster. The cluster controllers can be stimulated through the probe points and can also be monitored through the probe points. In the past, it has frequently been necessary to wire wrap electrical connections from the probes to a receiver panel of the tester. This is costly, and also degrades the signals that are to be monitored, which hinders the test equipment from accurately evaluating the gauge controller under test.

Another difficulty which is sometimes found in connection with the use of test equipment is the evaluation of bi-level digital signals. This problem is particularly noticeable in the case of controls for instrument panel clusters which can have numerous levels of control signals that depend heavily upon a large number of varying controller inputs. The evaluation of these forms of control signals has also been found in the past to be problematic and difficult due to the transient nature of their signals. Development of techniques to evaluate bi-level digital signals from a controller would, therefore, be useful.

### SUMMARY

This section provides a general summary of the disclosure, and is not a comprehensive disclosure of its full scope or all of its features.

A system for testing the output of a controller is disclosed. The system has a data entry interface configured to receive a multi-component control signal from a digital controller. The system initializes a test module to detect if a first expected level is detected in a first high frequency component of the multi-component control signal. If the first expected level is not met, an error signal is produced. If the first expected level is met, the system detects if a second expected level is met in a second component having a lower frequency of a multi-component control signal. If the second expected level is not met, the system will loop and reevaluate both the first and second components of the multi-component control signal. If the first and second components then meet the first and second expected levels, the system then evaluates if a third expected level is met for a third component of the multi-component signal.

According to an alternate teaching, a system for testing the output of a digital gauge controller is disclosed. The system is configured to receive a multi-component digital signal and test if a first expected level is reached for a higher frequency first component of the multi-component digital signal. If the first expected level is not met, the system issues a warning. If the first expected level is met, the system then determines if a second component having a lower frequency of the multi-component signal meets a second expected level. If the second expected level is reached, the system will determine if a third component of the multi-component signal having a yet lower frequency meets a third expected level. If the third expected level is not met, the system will reevaluate at least the second and third components to determine if the second and third signals meet the second and third levels.

According to an alternate teaching, a system for testing the output of a digital gauge controller is disclosed. The system is configured to receive a digital control signal having at least three separate frequency components. The system is configured to test if a first expected level is reached related to a first digital signal having a first frequency. If the first expected level is reached, the system then determines if a second expected level is reached by a second digital signal having a frequency lower than the first signal of the multi-component signal. If the second expected level is not reached by the second digital signal of the multi-component signal, then the system reevaluates both the first and second digital signals of the multi-component signal. If these second evaluations do not produce a positive result, then an error signal is generated.

According to an alternate teaching, a method for evaluating a gauge controller is disclosed. The method includes receiving a digital multi-component signal having at least three separate frequency components. The method includes testing if a first expected level is reached related to a first digital signal of the multi-component signal, and if the first expected level is reached, then determining if a second expected level is reached by a second digital signal of the multi-component signal where the second digital signal has a frequency higher than the first frequency. If the second expected level is not reached by the second digital signal of the multi-component signal, then reevaluate both the first and second digital signals of the multi-component signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. The present disclosure will become more fully understood from the detailed description and the accompanying drawings, wherein:

FIG. 1 is a diagram of an example variable instrument cluster according to the present disclosure;

FIG. 2 is a functional block diagram of an example test system according to the present disclosure;

FIG. 3 is an example graph of a multi-component controller signal according to the present teachings; and

FIG. 4 is a flow chart of an example controller test method according to the present disclosure.

Corresponding reference numerals indicate corresponding parts throughout the several views of the drawings.

### DETAILED DESCRIPTION

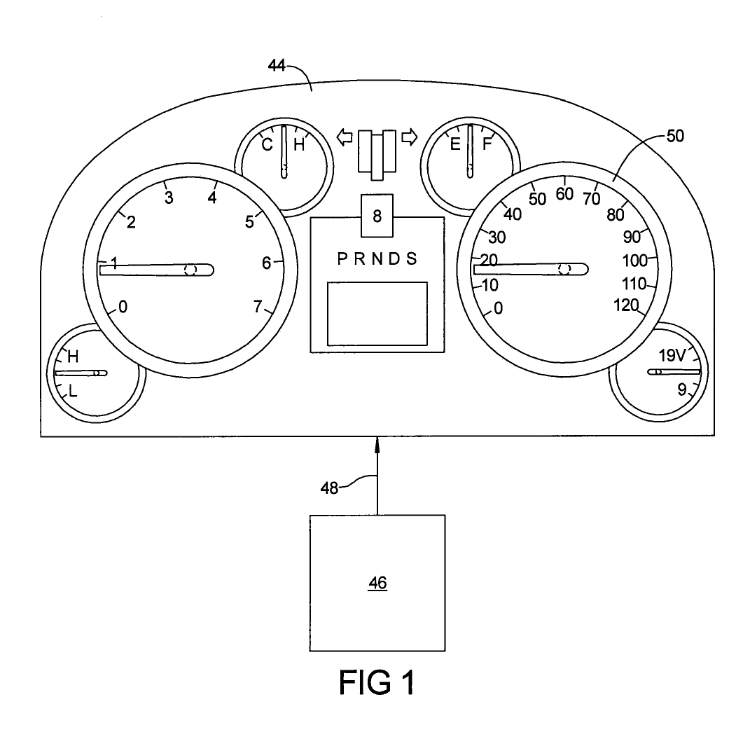

Example embodiments will now be described more fully with reference to the accompanying drawings. FIGS. 1 and 2 represent a diagram of an example variable instrument cluster and functional block diagram of an example test system according to the present disclosure. The exemplar variable instrument cluster 44 is a programmable display which accepts multi-component controller signal from a digital controller 46. As described in detail below, the multi-component controller signal 48 is a digital signal formed of various digital frequency components. The variable instrument cluster 44 is configured to interpret these signals to vary the display 50. As can be appreciated, the control logic of the multi-component signal 48 can be very complicated, and can change depending on signals which are based on environment conditions.

FIG. 2 represents a functional block diagram of an example test system according to the present disclosure configured to test, for by way of example, the controller 46 shown in FIG. 1. The multi-component control signal 48 is optionally read in real time or can be stored in a log 54 associated with a processor 55. A data store 56 stores a plurality of evaluation procedures 58, where each evaluation procedure 58 specifies one or more event thresholds for evaluating the multi-component control signal 48. An administrative module 60 operates selectively to analyze the multi-component signal 48 in the log 54 and select specific evaluation procedures 58 from the plurality of evaluation procedures.

An administrative module 60 is in data communication with the data store 56 and operable to receive data from the log 54 and apply one of the specific evaluation procedures 58 in accordance with a structured evaluation procedure 64. The administrative module 60 functions to apply various testing criterion 66 to individual components 62 the multi-component signal 48. This testing criterion 66 can be, for example, the emergence of a signal edge at a predetermined time. Similarly, the testing criterion or expected value can be the detection of a leading or tailing edge within a predetermined time span. The time span can be a predetermined value which is based on an expected output for a given environmental input to the controller. This expected value can have a tolerance band which is defined in time space. Additionally, the expected value can be the detection of the time rate of change of a pulse or the time location of a trailing edge of an individual component 62.

The administrative module 60 can compare a first digital component 62 of the multi-component signal 48 the signal to determine if the first expected value has been met. For example, the administrative module 60 can determine if a first edge 68 was detected within a predetermined time window 70. Should the first expected value not be met, the system will issue an error signal 72. In the event the first expected value is met, the administrative module 60 will evaluate a second component of the multi-component control signal 48 stored in the log 54 to determine if a second component 62 of the multi-component signal 48 meets the second expected value as defined by a second specific evaluation procedure 58. If the second component of the multi-component signal does not meet the second expected value, the administrative module 60 will again check, first, the first expected value as defined by the first evaluation procedure 58, then the second component using the second expected value as defined by the second evaluation procedure 58. Should both the first and second criterion not been met for a second time, error signal 72 is issued.

Should the first and second expected values be met the second time, the administrative module 60 will then check to see if a third expected value is met by a third component of the multi-component signal 48. This evaluation is defined by a third evaluation procedure 58. If the third expected value is met, the administrative module 60 can issue a signal indicative of the controller passing the tests. Additionally, if further evaluation of portions of the multi-component signal 48 are required, these can be checked as described above. Should the third expected value not fall within acceptable levels, then the system can return to one of the first or second evaluation procedures 58 to recheck the first and second expected values as defined by either the first or second evaluation procedure 58 as well as recheck the third.

The data entry interface coupled to the output line at the controller 20 contains a data acquisition system having a sampling rate of about 10⁶ samples/per second. This data acquisition system is configured to acquire the pulse modulated control signal from the controller.

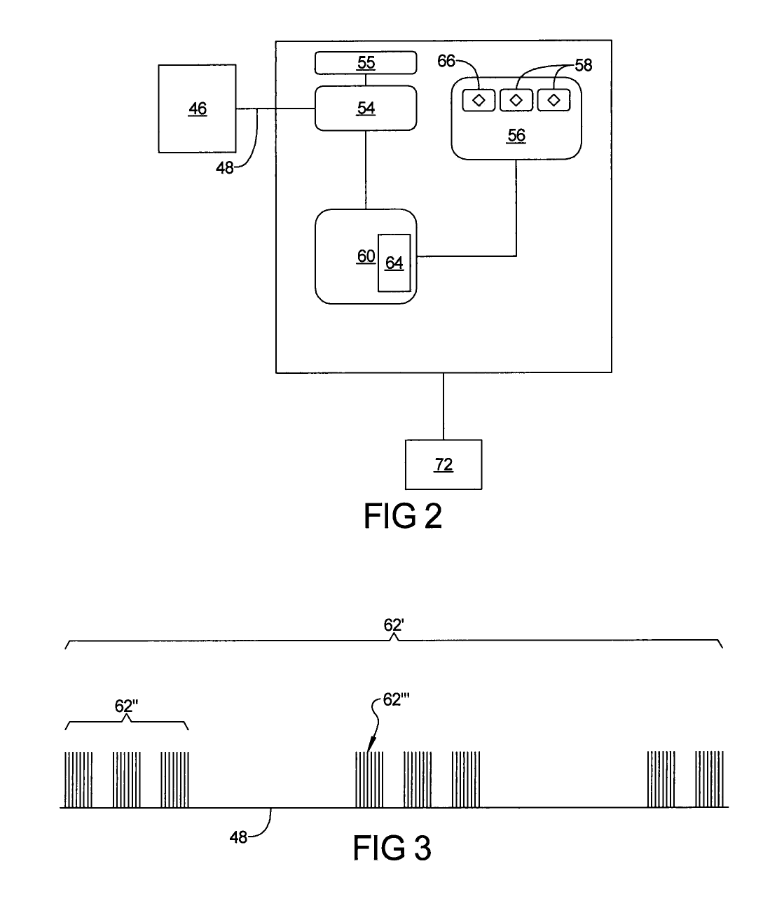

Data from the data entry interface can be transferred to the log for short term storage. The administrative module then evaluates the multi-component signal 48, an example of which is shown in FIG. 3. The multi-component signal 48 can be formed of multiple digital components 62′-62′″ having a plurality of disparate frequencies. For example, the nested periodic output can have a period of 1000 ms and a duty cycle of 44%, a period of 167 ms and a duty cycle of 62%, and a period of 13 ms and a duty cycle of 33%. For the above signal, the expected test value can have a tolerance of, for example, of the transition of the signal voltage within an expectation window. This represents a passing signal. Should all transition tests of the individual components of the multi-component signal 48 pass, a signal indicative of an acceptable controller is issued. In the event an error signal is initiated, the system can give a signal that the controller has not passed the requisite test.

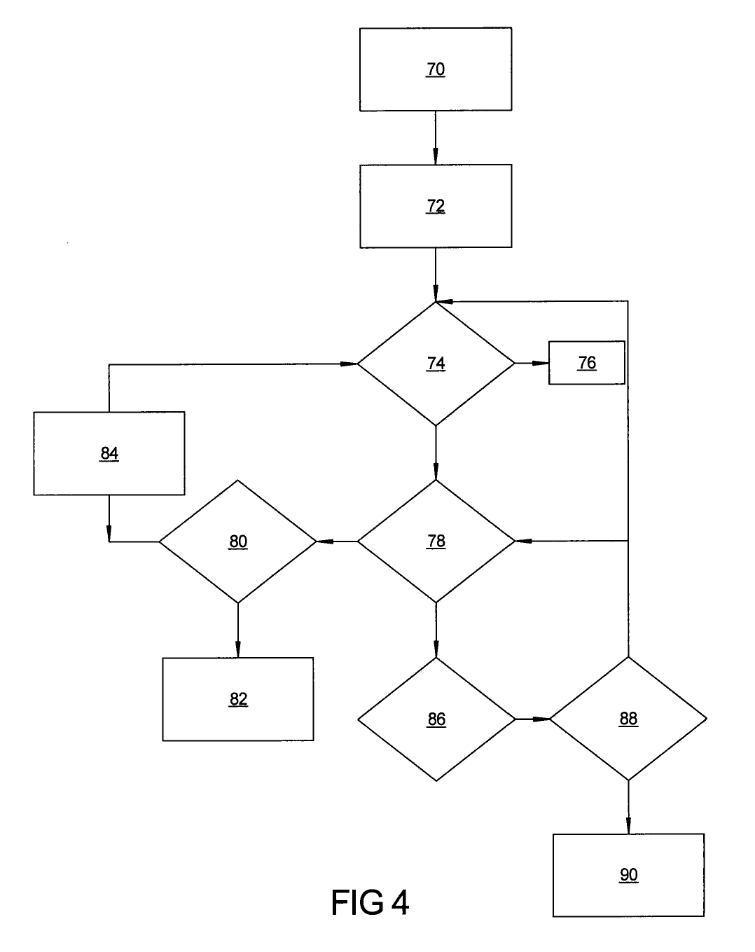

FIG. 4 is a flow chart of an example controller test system describing a method of applying the test regimes according to the present disclosure. A method for evaluating a gauge controller, includes in process block 70 receiving a digital multi-component signal having at least three separate components having varying frequencies. In process block 71, the digital multi-component signal can be stored in a data log. In query block 74, a test is conducted to determine if a first expected level is reached related to a first digital signal of the multi-component signal. The first digital signal can be the highest frequency component of the signal. The second digital signal can be a component of the multi-component signal having a lower frequency than the first component. If the first expected level is not reached, an alarm is set in process block 76. If the first expected level is reached, then in query block 78 determines if a second expected level is reached by a second digital signal of the multi-component signal.

If the second expected level is not reached by the second digital signal of the multi-component signal, query block 80 determines if a recursion flag is set. If the recursion flag is set, an alarm is issued in process block 82. If the recursion flag is not set the query block allows the reevaluation both the first and second digital signals of the multi-component signal in query blocks 74 and 78. The recursive flag is set in process block 84. If the reevaluate of both the first and second digital signals of the multi-component signal do not produce a positive result, then generate an error signal in process block 82.

If the reevaluate of both the first and second digital signals of the multi-component signal produce a positive result, the method determines if a third expected level is reached related to a third digital signal of the multi-component signal in query block 86. The third digital signal can have a frequency less than both the first and second digital signal. If the third digital signal does not meet the third expected level in query block 84, then the method reevaluate one of the second and third digital signals or the first, second and third digital signal of the multi-component signal. Should the third digital signal meet the third expected value, the system can issue a signal indicative of a controller passing the required tests.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for evaluating a gauge controller comprising:
coupling a gauge controller having an input and an output to a test fixture;
inputting a predetermined input signal indicative of a gauge input into the gauge controller input;
reading a signal indicative of a multi-component digital output from the controller output;
applying a first structured test procedure to a first component of the signal indicative of the multi-component output, the first component having a first frequency;
applying a second structured test procedure to a second component of the signal indicative of the multi-component output, the second component having a second frequency less than the first frequency; and
should the second component of the signal indicative of the multi-component digital signal not meet an expected value, reevaluate both the first and second components of the signal indicative of the multi-component signal.

2. The method according to claim 1, further comprising:
applying a third structured test procedure to a third component of the signal indicative of the multi-component signal, said third component having a third frequency less than the first frequency.

3. The method according to claim 1, wherein if the third component does not meet a second expected value, reevaluating one of both the second and third components of the signal indicative of the multi-component signal or each of the first, second, and third components of the signal indicative of the multi-component signal.

4. The method according to claim 1, wherein reevaluating the first and second component of the signal indicative of the multi-component signal is both comparing a portion of the first signal to a first expected value and comparing a portion of the second signal to a second expected value.

5. A computing device for evaluating a digital controller for a gauge, comprising:
a data entry interface configured to receive a multi-component control signal from the digital controller for a gauge and store data based on the multi-component control signal in a log;
a data store that stores a plurality of structured test procedures, where each of the structured test procedures specifies an expected level measure; and
an administrative module in data communication with the data store and operable to apply a first one of the structured test procedures to a first component of the data based on the multi-component signal, said first component having a first frequency, and apply a second one of the structured test procedures to a second component of the data based on the multi-component signal, said second component having a second frequency less than the first frequency, should the second component of the data based on the multi-component signal not meet an expected value, the administrative module reevaluates both the first and second components of the data based on the multi-component signal.

6. The computing device according to claim 5, wherein the administrative module applies a third one of the structured test procedures to a third component of the data based on the multi-component signal.

7. The computing device according to claim 6, wherein if the third component does not meet an expected value, the administrative module reevaluates either:
a) one of the second and third components or
b) the first, second and third components of the data based on the multi-component signal.

8. The computing device according to claim 5, wherein the expected value is a location of a signal edge in time.

9. The computing device according to claim 8, wherein the expected value has a tolerance band.

10. The computing device according to claim 5, wherein the first component of the data based on the multi-component signal is a digital signal having a first frequency.

11. The computing device according to claim 10, wherein the second component of the data based on the multi-component signal is a digital signal having a second frequency higher than the first frequency.

12. The computing device according to claim 5, wherein the data based on the multi-component control signal is a digital pulse signal formed of a plurality of signals each having different frequencies.

13. A computing device for evaluating a digital controller, comprising: an administrative module configured to receive a multi-component digital signal and test if a first expected level is reached for a first component of the multi-component digital signal, if the first expected level is not met, the administrative module issues a warning, if the first expected level is met, the administrative module then determines if a second component of the multi-component signal meets a second expected level, if the second expected level is met, the administrative module will determine if a third component of the multi-component signal meets a third expected level, if the third expected level is not met, the administrative module will reevaluate at least the second and third components of the multi-component signal to determine if the second and third components of the multi-component signal meet the second and third levels.

14. The computing device according to claim 13, wherein the administrative module reevaluates the first, second and third components of the multi-component signal to determine if the first, second and third signals meet the first, second and third expected levels.

15. The computing device according to claim 13, wherein if the third component does not meet one of the first, second, or third expected levels, the administrative module reevaluates one of the second and third components of the multi-component signal or the first, second and third components of the multi-component signal.

16. The computing device according to claim 13, wherein the first expected level is a location of a signal edge in time.

17. The computing device according to claim 16, wherein the expected level has a tolerance band.

18. The computing device according to claim 13, wherein the first component of the multi-component signal is a digital signal having a first frequency.

19. The computing device according to claim 18, wherein the second component of the multi-component signal is a digital signal having a second frequency lower than the first frequency.

20. The computing device according to claim 13, wherein the multi-component control signal is a digital pulse signal formed of a plurality of signals each having different frequencies.

21. A method for evaluating a gauge controller, comprising:
receiving a digital multi-component signal having at least three separate frequency components;
testing if a first expected level is reached related to a first digital signal of the multi-component signal, and if the first expected level is reached, then determining if a second expected level is reached by a second digital signal of the multi-component signal, and if the second expected level is not reached by the second digital signal of the multi-component signal, then reevaluating both the first and second digital signals of the multi-component signal, wherein the second digital signal has a frequency lower than the first digital signal.

22. The method for evaluating a gauge controller according to claim 21 wherein if the reevaluating of both the first and second digital signals of the multi-component signal does not produce a positive result, then generate an error signal.

23. The method for evaluating a gauge controller according to claim 21 further comprising testing if a third expected level is reached related to a third digital signal of the multi-component signal, wherein the third digital signal has a frequency lower than the second digital signal.

24. The method for evaluating a gauge controller according to claim 23 wherein if the third digital signal does not meet the third expected level, then reevaluate one of the second and third digital signals or the first, second and third digital signal of the multi-component signal.
